(19) United States
(12) Patent Application Publication
(10) Pub. No.: US 2004/0048646 A1
(43) Pub. Date: Mar. 11, 2004

(54) Electronic gaming device and method with moving bonus symbol and free games

(76) Inventor: Martin Visocnik, Indooroopilly (AU)

Correspondence Address: Anderson & Morishita, L.L.C., Suite 102, 2725 S. Jones Blvd., Las Vegas, NV, 89146, US

(21) Appl. No.: 10/242,260

(22) Filed: Sep. 11, 2002

(51) Int. Cl. A63F 9/24; A63F 13/00; G06F 17/00; G06F 19/00

(52) U.S. Cl. 463/16

(57) ABSTRACT

An improved gaming device and method are set forth where a base game is played is played using representations of slot machine reels and game symbols. A trigger outcome of the base game triggers a bonus sequence of a plurality of free games. During the free game sequence, a bonus symbol is moved to impart, acquire, change and interact with base game symbols. The bonus symbol is displayed in the game as superimposed, juxtaposed or coordinate sharing configuration. The attributes of the bonus symbol may change during the bonus sequence.

### FIELD OF THE INVENTION

The present invention relates to electronic, video, slot machine games and game methods, including games for play on the Internet. More particularly it relates to electronic, video slot machines of the type, which have a bonus sequence including one or more bonus symbols.

### BACKGROUND

Slot machines are well known gaming devices. In the past they have been embodied as first mechanical and later electro-mechanical devices having three or more reels. Each reel includes about its periphery a plurality of symbols (and blanks). When play is initiated as by inserting a wager and pulling a handle, the reels are spun eventually slowing to present symbols or blanks at a pay line. If the combination of symbols is one of a predetermined schedule of winning outcomes, the player receives a reward. If the outcome is a losing outcome, the player loses their wager.

Recently it has been known to provide video displays controlled by a processor, which simulates spinning reels and the presentation of winning or losing outcomes. Furthermore it has been known to provide these devices with bonus sequences, which are triggered by the player obtaining certain outcomes during play of the primary game. One such game is a game wherein five reels are displayed. The player makes a wager to enable from one to five or more pay lines. When play is prompted, the processor is prompted to control the display to simulate the spinning of the reels and the eventual presentation of outcomes. If the player has a winning outcome on any enabled pay line they receive a reward. Awards may also be issued for combinations of game symbols appearing scattered on the display, referred to in the industry as “scatter pays”. If the player receives a bonus enabling outcome, the display switches to a bonus display screen. The player is prompted to make a selection from various displayed options to secure/reveal a bonus.

These types of second screen bonus game have gained popularity in casinos.

In another type of game, when the player obtains a predetermined outcome during play of the game, a sequence is initiated wherein a wild symbol marches through the display creating different combinations and different pay outs. One such game is as described in Australian Patent AU-B-43613/97 published Feb. 5, 1998 by Bennett and titled “Slot Machine With Roaming Wild Symbol”.

Another type of bonus game is disclosed in Glasson, U.S. Pat. No. 6,200,600 issued Sep. 18, 2001 and titled “Electronic Game With Moving Bonus Symbols”, the disclosure of which is hereby incorporated by reference. In this reference there is disclosed a game where, when a bonus is triggered, a feature character moves to adjacent reels which display landing symbols to determine the bonus. During the bonus feature, the reels are not re-spun and only the feature symbol moves. In a like fashion, in Jaffe, European Patent Office published application EP 1 150 261 A2 titled “Gaming Machine With Moving Bonus Symbols On An Array”, published Oct. 31, 2001, there is shown another game where a feature symbol moves across a static display to determine the bonus for the player.

There have also been games where there is an applied, persistent, bonus symbol. In Barrie, U.S. Pat. No. 5,833,537 issued Nov. 10, 1998 and titled “Gaming apparatus and method with persistence [sic] effect”, the disclosure of which is also incorporated by reference, there is disclosed a game where, when an event triggers a bonus, a bonus indicator is positioned on the game display matrix which affects the pay out for the game, e.g. the symbol may act as a multiplier for any winning outcome including the bonus symbol. This symbol persists at its assigned matrix coordinate through subsequent games for which the player has wagered upon until a terminating event such as a number of games have been played or a bonus terminating outcome has occurred.

Bonus games are, as stated above, popular among players. However, one drawback is that, in one type of machine, the player only gets to select symbols as a means for randomly selecting a bonus. The player, by obtaining a bonus enabling outcome, knows they are going to obtain a bonus, he just does not know how much. There is no means by which the player might expect to increase his bonus during play or presentation of the bonus sequence. With roaming wild symbols, the prize of the feature depends on combinations created by the roaming wild symbol while moving from position to position across a static display.

Further, in these prior games, either the bonus is awarded by a separate game outcome, e.g. play of a bonus game, based upon a stagnant game display or, where a persistent symbol is used, requires the player to wager and play additional games to obtain an award including the persistent symbol. For example, if the bonus is initiated on the last play and the player is out of money or game credits, they player cannot play the bonus game with the persistent symbol without obtaining additional funds.

Further, since there are many gaming options in modern casinos, which compete for the player's attention and which provide generally the same return, there is a need for a game, which provides enhanced entertainment value for the player.

### SUMMARY OF THE INVENTION

There is, therefore, set forth according to the present invention an improved electronic gaming machine and method, which provides a base game and an entertaining bonus feature and which overcomes the drawbacks of prior gaming devices.

Toward this end there is set forth a method and improved electronic gaming device of the type including an electronic display, means for accepting wagers to play a series of game plays and a controlling game processor programmed to, when prompted, control the display to display at least three, and up to six, reels each in a spinning mode concluding at a stopped mode whereat a plurality of reel symbols are displayed on said reels defining a matrix of coordinates occupied by symbols and defining a winning or a losing base game outcome. Based upon the symbol combinations along enabled pay lines or scattered on the display, winning outcomes are obtained. If a winning base game outcome is obtained, the processor controls award issuing means to issue the award, e.g. game credits, for each winning outcome.

The improvement includes programming the processor to sense the occurrence of a predetermined bonus triggering event which may be a combination of symbols, count of value of previous wagers (referred to in the industry as “coin in”), time, based on a number of outcomes of distinct base games or other event. In response to sensing said triggering event, the processor is configured to initiate a bonus sequence, which includes (i) re-configuring the game for at least one free game play. That is, during the bonus sequence, the processor will select and control the display to display a series of new games without the player making any additional wagers until termination of the bonus sequence. The processor, upon initiation of the bonus sequence controls the display to assign and display a bonus symbol at a game matrix coordinate in one or an overlaid or underlaid configuration with any symbol displayed on the game matrix. The coordinate for the bonus symbol may be randomly selected or may be based upon the coordinate of a triggering, base game symbol or the position may be fixed for the start of the bonus sequence. For example, the bonus symbol may be “Mouse” which is displayed as a “ghost” or watermark symbol at the assigned coordinate such that the game symbol occupying the same coordinate is not obscured. For the games played during the bonus sequence, the presence of the Mouse affects the award offered to the player. The Mouse may be Wild to complete any base game or free game winning outcome, may provide scatter pays based upon other game symbols occupying the same symbol coordinate, e.g. if the Mouse occupies the same coordinate as a cheese symbol, the combination of cheese symbols displayed pays for scatters as award is obtained. The Mouse may have a set of properties that may be in addition or at exclusion of its other properties. For example the Mouse may have two properties, of being wild and of multiplying the prizes when substituting in a win combinations. Thus the Mouse would not only act as wild but also as a multiplier. Further the properties of the Mouse may be selectable during each spin of the free games, for example the Mouse may have either the property of being Wild, or of awarding a fixed prize or of awarding an additional free game. At the beginning of a free game the property of the Mouse would be selected (for example randomly selected). Thus if the fixed prize property would be selected the Mouse would be defining an award. Further to properties being selectable, properties may need certain conditions to be activated. The Mouse properties may be activated depending on the outcome of a free game e.g. the multiplier property of the Mouse may depend on the game outcome displaying a Cheese symbol.

The Mouse symbol from the first game of the sequence persists on the display until a new free base game outcome is obtained at which time the bonus symbol Mouse would move to another coordinate position with the same effect. Game symbols may affect the movement of the bonus symbol such as, if the Mouse is on reel 1 and a game symbol “Cheese” appears on reel 5, the Mouse may be displayed in a fanciful manner as moving toward the Cheese symbol to another coordinate. At each free game and when the bonus symbol has been re-positioned, the processor compares the outcome and issues all winning awards. The number of free games during the bonus sequence may be fixed, e.g. ten games, or may be dictated by the appearance of a terminating symbol, e.g. a Cat symbol occupying the same coordinate as the bonus Mouse symbol. From free game to free game and with references to bonus symbol properties mentioned before, the properties of the bonus symbol may increase or decrease, may be gained, supplemented or lost, disposed off or passed on. For example the Mouse may gain the property of a shield against Cats and may pass this property on when exiting the free games in favor of a second Mouse symbols that may be displayed. Thus a Cat symbol occupying the same coordinate as the bonus Mouse symbol with the shield property would not terminate the free games series.

The number of free games may also depend on the current properties of the Mouse symbol or the current properties of other game symbols, e.g. if the Mouse has to feed on Cheese symbols to continue the sequence of free games, a succession of free games outcomes that would not result in displaying the Cheese symbol would cause the termination of the free games series. Upon termination, the aggregate of all bonuses issued during the bonus sequence is awarded to the player and the player is returned to the base game for the input of another game play wager.

As a further feature, if during a first bonus sequence the free games produce a second bonus trigger, a second bonus symbol is entered into the bonus sequence. Hence a player may have two Mouse symbols moving about the matrix to define winning outcomes or to confer their assigned or selected properties.

In an alternative embodiment, the companion symbol at each coordinate position occupied by the Mouse may persist through the series of free games. Thus, if the bonus symbol first occupies a Cheese symbol and in the next game moves to occupy a Cherry symbol, these symbols would persist at their coordinate locations for the bonus sequence. Thus the moving bonus symbol “locks” the companion game symbol in its position in the matrix during the bonus sequence and any winning or losing combinations are determined using those locked symbols.

Still further, the bonus symbol may interact with the underlying or overlying game symbols by defining an award, e.g. Mouse overlies a Cat symbol, as suggested above, can terminate the bonus game set. Still further, the bonus symbol or an image originating from the bonus symbol may temporarily move to symbols adjacent to the bonus symbol to define additional awards, e.g. Mouse reaches with his paw to a Cheese symbols displayed revealing each time a prize. Still further, at each coordinate occupied by the bonus symbol may transform the underlying or overlying game symbol into a new symbol, which persists during the bonus sequence or which in turn interacts with other displayed symbols. The bonus symbol as suggested above may also transfer or pass on some of its properties to game symbols as well as game symbols may transfer their properties to the bonus symbol. Thus properties such as Wild may be gained or lost by the bonus symbol or be gained or lost by any other game symbols. Properties that may be gained or lost include the property of persisting in the successive free game and of moving to new coordinates of the display matrix.

The properties that the bonus symbol or game symbols may have can be of a variety of types, and would include multiplying prizes, being wild, duplicating other symbols or themselves, activating symbols or symbols properties, modifying or mutating symbols, being able to move symbols to new coordinates, defining special awards, changing properties of groups of symbols or of alike symbols or initiating separate features. The properties themselves may require a number of parts to be active or may increase or decrease depending on free games outcomes.

Still further, the bonus symbol may interact with activator symbols to start an additional feature that may be displayed in a fanciful manner to define additional awards e.g. the Mouse symbol may interact with an activator symbol shown as a “Pulley” which would start a feature of lowering “Curtains” over some of the game symbols and the player via a touch screen interface selecting one or more of the game symbols covered by a curtain unveiling so feature symbols and defining awards.

In a further embodiment the processor when sensing a predetermined bonus triggering event would initiate the bonus sequence and control the display to assign and display a number of bonus symbol at game matrix coordinates where the various bonus symbols would have possibly differing properties. For example the free games series may start with two bonus symbols of the Mouse and the terminating Cat symbol being displayed on the matrix. The bonus symbols movements would be affected by game symbols in the manner mentioned before where, for example, the Mouse symbol moves towards the Cheese symbol. The free games series would terminate once the Cat and the Mouse symbol would move to adjacent coordinates on the matrix. Thus the bonus symbols may not be all advantageous to the player but some may have properties that limit or hinder possible definitions of awards. Further bonus symbols may be, as mentioned before, in an overlaid or underlaid configuration with any symbol displayed on the game matrix or may be displayed instead of game symbols occupying the same matrix coordinates, thus only one symbol occupying a matrix coordinate at a time.

The game method and improved device thus provides for an entertaining bonus sequence where the bonus symbol moves through the matrix as free games are played affecting symbols and pays. Further, during the bonus sequence, the player need not make additional wagers.

### BRIEF DESCRIPTION OF THE DRAWINGS

These and other features and advantages will become appreciated as the same becomes better understood with reference to the description, claims and drawings wherein:

FIG. 1 shows a display of the base game and an example of a bonus triggering condition;

FIG. 2 shows the display of FIG. 1 with an example of a superposed bonus symbol;

FIG. 3 shows the display of FIG. 1 with the bonus symbol being assigned a Wild attribute and persisting to the display for the next game and the spin of the game reels;

FIG. 4 shows an example of a subsequent game display with the overlying/underlying bonus symbol and base game symbols to define a bonus game outcome;

FIG. 5 shows the movement of the bonus symbol to another position in the game display for the next free game;

FIG. 6 shows another example of the movement of the bonus symbol as influenced by a game symbol;

FIG. 7 shows the display of FIG. 5 after the symbol has moved and the symbol persisting through the next spin of the game reels;

FIG. 8 shows another example of the movement of the bonus symbol as influenced by a game symbol;

FIG. 9 shows the overlying bonus symbol and a bonus terminating underlying symbol to terminate the bonus event;

FIG. 10 is a simplified logic diagram for operation of the game;

FIG. 11 shows an example of the bonus symbol being located in proximity of two treasure symbols for revealing an award;

FIG. 12 shows the display of FIG. 11 with the bonus symbol interacting with the first treasure symbol and revealing a prize;

FIG. 13 shows the display of FIG. 12 with the bonus symbol interacting with the second treasure symbol and revealing a second prize;

FIG. 14 shows an example of two bonus symbols being located in proximity of one treasure symbol, and the first bonus symbol interacting with the treasure symbol and revealing a prize;

FIG. 15 shows the display of FIG. 14 with the second bonus symbol interacting with the treasure symbol and revealing a second prize;

FIG. 16 shows another display of the base game and another example of a bonus triggering condition;

FIG. 17 shows the display of FIG. 16 where the bonus symbol appears at the coordinates of one of the symbols of the trigger condition, in an overlaid configuration;

FIG. 18 shows an example of a further bonus triggering condition during a bonus game series, and where a further bonus symbol appears at the coordinates of one of the symbols of the trigger condition, in an overlaid configuration;

FIG. 19 shows a bonus game where a messenger symbol, a new symbol that originated at the coordinates of a bonus symbol of FIG. 18, is seen interacting with a treasure symbol and revealing a prize;

FIG. 20 shows an example with the bonus symbol overlying/underlying a game symbol, shown as a key, with a special property to define a bonus game outcome where the bonus symbol acquires a new property from the game symbol;

FIG. 21 shows an example of a bonus game subsequent to the game of the display of FIG. 20 where the bonus symbol with the new property disposes of the new property by placing a game symbol (key) with the special property on one of the coordinates of the display;

FIG. 22 shows another example of a bonus game where the bonus symbol is in proximity of a game symbol with a special property, and where this game symbol will persist into the next free game;

FIG. 23 shows an example of a bonus game subsequent to the game of the display of FIG. 22 where the bonus symbol has acquired the special property from the game symbol that persisted;

FIG. 24 shows an example of the display of FIG. 23 during a successive bonus game of the bonus game series where the bonus symbol with the newly acquired property interacts with a game symbol (diamond) that has the property of being able to be split into a number of symbols;

FIG. 25 shows the display of FIG. 24 where the games symbols have divided into a number of symbols, which are being scattered around the display;

FIG. 26 shows the display of FIG. 25 where the symbols originated from the split symbol have reached their new display co-ordinates;

FIG. 27 shows an example of the bonus symbol in proximity of a duplicating symbol shown as a mirror, a symbol that has the property of duplicating other symbols on the matrix;

FIG. 28 shows the display of FIG. 27 where the duplicating symbol detects the bonus symbol.

FIG. 29 shows the display of FIG. 28 where the duplicating symbol duplicates the bonus symbol at new display co-ordinates;

FIG. 30 shows the bonus symbol in proximity of a game symbol (soccer ball) that has the property of being able to be relocated on the display matrix;

FIG. 31 shows the display of FIG. 30 where the bonus symbol is interacting with the game symbol and this symbol is moved from its original co-ordinates on the display.

FIG. 32 shows the display of FIG. 31 where the game symbol has moved to new display co-ordinates and where this symbol has also interacted with another game symbol before reaching the new display co-ordinates and in doing so revealing a prize;

FIG. 33 shows the bonus symbol in proximity of an activator symbol (water valve) initiating an activator symbol sequence;

FIG. 34 shows the display of FIG. 33 where as an example of the activator symbol sequence, a number of game symbols (water fountains) that have the property of awarding prizes are displayed at various coordinates of the display;

FIG. 35 shows the display of FIG. 34 where the bonus symbol interacts with the activator symbol revealing prizes at some of the game symbols with such property;

FIG. 36 shows the display of FIG. 33 where in another example of the activator symbol sequence, certain symbols of the display are moved from their original display coordinates to new display coordinates;

FIG. 37 shows the display of FIG. 36 where the symbols that moved to the new display coordinates form a win combination and the game awards a prize;

FIG. 38 shows an example of the bonus symbol (in this example it does not have the property of being wild) acquiring a new property related to the symbol overlying/underlying the bonus symbol;

FIG. 39 shows an example of a bonus game subsequent to the game of the display of FIG. 38 where the bonus symbol, by using the property acquired in the display of FIG. 38, forms a win combination with symbols displayed along a pay line and the game awarding a prize;

FIG. 40 shows another example of a bonus game subsequent to the game of the display of FIG. 38 where the bonus symbol by using the property acquired in the display of FIG. 38 forms a match with the symbol overlying/underlying the bonus symbol and the game awarding a prize;

FIG. 41 shows another example of a bonus game where the bonus symbol has the property of being wild and of multiplying the prize of win combinations by the multiplier displayed on the bonus symbol;

FIG. 42 shows a bonus game subsequent to the display of FIG. 41 where the bonus symbol has progressed to the next coordinates on the display and where at the previous coordinates of the bonus symbol a companion symbol is displayed with a reduced multiplier with respect to the bonus symbol;

FIG. 43 shows a bonus game subsequent to the display of FIG. 42 where the bonus symbol has again progressed to the next coordinates on the display and where a new companion symbol is displayed at the immediately proceeding coordinates of the bonus symbol, and where the companion symbol of the display of FIG. 42 persists in the current display but with the a reduced multiplier and where the game is awarding a prize for a combination obtained with a companion symbol and multiplying the prize awarded by the multiplier displayed on the companion symbol;

FIG. 44 shows yet another example of a bonus game where the bonus symbol has the property of being wild and of persisting in subsequent bonus games by the number of times indicated on the bonus symbol;

FIG. 45 shows a bonus game immediately subsequent to the display of FIG. 44 where the number indicated on the bonus game has been reduced by one, and the bonus symbol is adjacent to a refill symbol, a symbol that can increase properties of the bonus symbol;

FIG. 46 shows the display of FIG. 45 where the bonus symbol is interacting with the refill symbol, and the refill symbol increasing the number indicate on the bonus symbol by the number indicated on the refill symbol in FIG. 45;

FIG. 47 shows another example of a bonus game where the bonus symbol has a number of properties but not all being active in every bonus game;

FIG. 48 shows a bonus game subsequent to the display of FIG. 47 where the active property of the bonus game forms a winning combination with symbols on the display and the game awarding a prize;

FIG. 49 shows another example of a bonus game where the bonus symbol has the property of changing the win evaluation method of the symbol overlying/underlying the bonus symbol;

FIG. 50 shows a bonus game subsequent to the display of FIG. 49 where the symbol overlying/underlying the bonus symbol is influenced by the property of the bonus symbol and is paying for scatters and the game awarding a prize; and

FIGS. 51-53 show an embodiment of the method and device of the present invention where a visiting symbol can be imported into the matrix to become a game symbol.

### DESCRIPTION

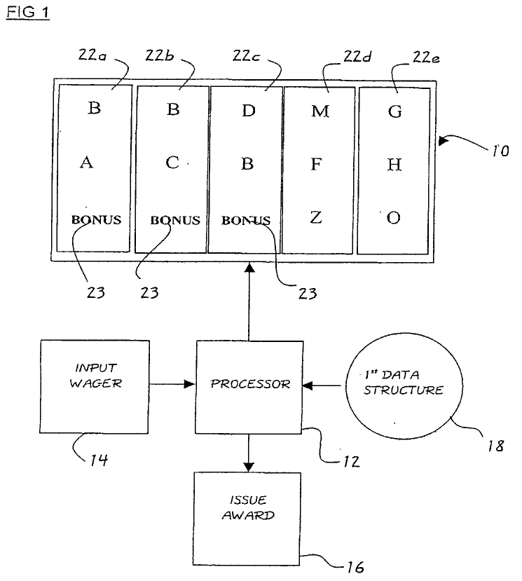

Turning to the drawings, the present invention includes the play of what will be referred to as a base game and play of a bonus game event. With reference to FIG. 1, the game includes a display 10 for a gaming machine of the type known in the art. The display 10 may be a VRT display, computer monitor, LCD or display TFT displays or the like. Further the display 10 may be of the type having a primary display and an overlying second, transparent LCD display. Any display 10 will suffice so long as it can be controlled to electronically display base game symbols and, as hereinafter described, bonus symbols.

The display 10 is controlled by a game computer processor 12 of the type known in the art. The processor 12 interfaces with a wager input device 14 which may be a coin or gaming token tester/receiver, or a card reader or some other device with the function of accepting credits as it is known in the art, a controller for wagering accumulated game credits or the like as is known in the art for a player to make a wager to play the game. An award device 16 may also be provided including, for example, a coin/token hopper and coin elevator, a ticket writer or the like as is known for issuing an award to the player. The award may be, again as is known in the art, the dispensing of coins or a ticket in the amount of accumulated gaming credits in response to a “cash out” prompt by the player.

To play the base game a player inputs a wager by the wager input device 14 and prompts the processor 12 for play. The processor 12, using a programmed random number generator, randomly selects from a first data structure 18 storing data representing game symbols, game symbols (individually, or as a complete outcome) and displays the same at the display 10 to define the base game winning, or losing, outcome. If the player has obtained a winning outcome the processor 12 determines the award (based upon the one or more winning symbol combinations) and issues the same by the award device to the player.

With continuing reference to FIG. 1, the game symbols are displayed at the display in a game matrix 20 representing five reels 22a-e, each reel having three rows thus defining a 3×5 game display matrix 20. Game symbols are located in the coordinates of the matrix 20 to define an outcome. While the present description is directed to a three line, five reel game, it should be understood that the present invention could also be used with a three-reel, nine-reel or any other game where a symbol matrix is randomly selected and displayed to define an outcome.

As is also well know in the art, the display 10 may include up to 243 pay lines, each play line embracing a symbol from one or more or all reels 22a-e and each pay line representing a unique combination of matrix 20 coordinates and hence game symbols. When a player plays the game they will input a wager which is allocated to and enables, for example, one to nine pay lines. When the outcome is selected and displayed at the display 10, the symbol combinations along each pay line is compared by the processor 12 to data representing a schedule of base game, winning, symbol combinations aligned along each enabled pay line. The player receives an award for each winning, base game, enabled pay line combination or for combinations formed by symbols that pay for scatters.

In response to prompting of play, the processor 12 randomly selects the base game outcome and controls the display 10 to display a simulation of the reels 22a-e spinning and stopping to display the base game symbols for the matrix. With reference to FIG. 1, there are shown letters each of which represents a game symbol or blank space for each coordinate for the matrix 20. As is common in the prior art, the symbols are caricatures, figures, photographs or other artistic figures and objects consistent with the desired theme of the game. For example, and as suggested in the drawings, the game may have a cat and mouse theme, or a pirates theme, a medieval theme or a car journey theme. Other themes may be presented as well with corresponding game symbols.

In addition to base game symbols, the first data structure also includes one or more trigger symbols 23 acting as triggers for the bonus game event. As shown in FIG. 1, these symbols may simply be the word “Bonus” or any other desired symbol or combinations of symbols which are designated as bonus triggers. As one example shown in the drawings, one bonus trigger is obtaining three “Bonus”, trigger symbols 23, on a pay line as suggested in FIG. 1. As a further example shown in the drawings, one bonus trigger is obtaining a “boat symbol” on reel 22a and an “island symbol” on reel 22e, scattered as suggested in FIG. 16. Other triggers for the bonus may be designated such as other symbol combinations, further scattered symbol combinations, symbols on two or more adjacent reels 22a-e, coin-in, by a random number generator (RNG), by sequence of outcomes during a number of base game play, by a signal issued by a linked controller or other events as is known in the art.

It should be noted that the outcome or event which triggers a bonus may also include a base game award, which is awarded to the player either before or upon conclusion of the bonus even as hereinafter described.

### The Bonus Game and Method According to the Present Invention

The present invention is directed to the configuration of the device and method regarding the bonus feature. It should be understood that the bonus and method of the present invention could be applied to any original or existing base game.

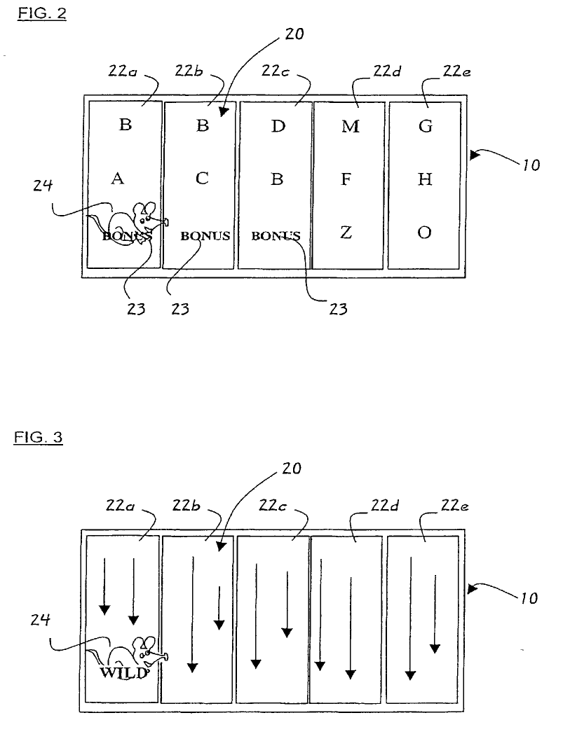

Once a bonus has been triggered, the processor 12 of the present invention selects and places a bonus symbol 24 (FIG. 2) in the game matrix. The original positioning of the bonus symbol 24 may be by random selection of a matrix coordinate or the placing may be scripted such as by placing the bonus symbol 24, shown, for example, as a mouse, at the leftmost coordinate having one of the triggering symbols. As shown in FIG. 2 the bonus symbol 24 has been located at the lower left coordinate of the matrix. The bonus symbol 24 may be a symbol which is consistent with the theme of the game and which is not a based game symbol. In this fashion the bonus symbol is easily distinguished from base game symbols and further creates and can be used, as hereinafter described, to configure new and appealing presentations during the bonus event.

A feature of the present invention is that the bonus symbol 24 is placed in the selected coordinate in an overlying, underlying, co-habiting or in juxtaposition with the displayed base game symbol, shown in FIG. 2 as “Bonus”. Alternately the processor may display the applied bonus symbol 24 flashing on and off with the base game symbol. Accordingly, the processor 12, to place the bonus symbol 24, selects the coordinate and reconfigures the displayed game symbol to show the desired overlying, underlying, alternating, co-habiting or juxtaposed relationship so as to occupy the same matrix coordinate. The display 10 may accordingly be controlled to flash between the game symbol and the bonus symbol 24, may show the bonus symbol 24 as a water mark symbol, as a lined ghost image or may show the game symbol as the watermark or ghost image with the more prominent bonus symbol 24. It should thus be understood that the processor 12 controls the display 10 to display both the bonus and the game symbols as being visible in the same coordinate(s). It is should be also understood that the bonus symbol 24 may be larger than other game symbols and thus the bonus symbol being displayed speared across a number of game symbol and portions of the bonus symbols being visible coexisting on the coordinates of a number of game symbols. The smeared or extended bonus symbol may transmit characteristics and features to (or conversely inherit attributes from) the number of game symbols.

In an additional or alternative embodiment of the present invention, the bonus symbol 24 may be displayed on the display 10 in a manner that the overlying, underlying, alternating, co-habiting or juxtaposed game symbol at the same coordinates on the matrix 20 as the bonus symbol 24 is not visible, and that only the bonus symbol is visible at least during certain states of the feature.

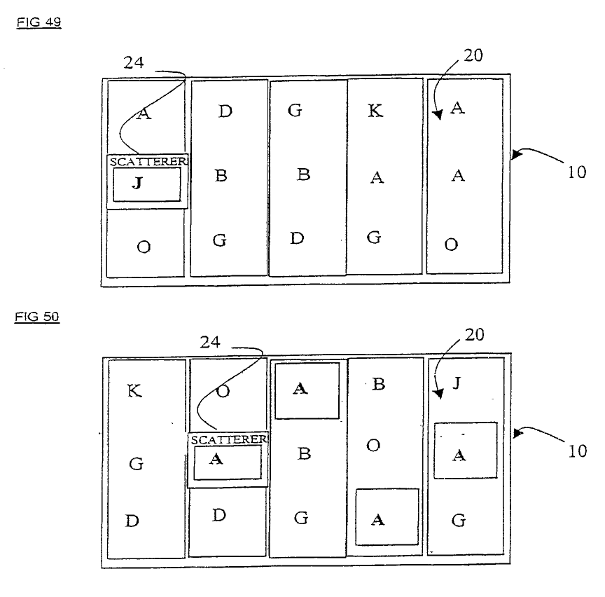

The assigned bonus symbol 24 carries with it one or more bonus attributes or properties such as being Wild for any base game symbol combination along an enabled pay line including the bonus symbol 24. Further attributes of the bonus symbol 24 may be to cause the overlying, underlying, alternating, co-habiting or juxtaposed game symbol at the same coordinates on the matrix 20, to assume special attributes or properties such as converting a the co-habiting game symbol into a scatter symbol and paying for scatter combinations of the converted game symbol as shown in FIG. 49. Thus the bonus symbol may cause all symbols alike to the symbol sharing the same coordinates in the matrix 20 as the bonus symbol 24 to pay for scatters during that free game. As in the example of FIG. 50, which may be a continuation of game of FIG. 49, the game symbol A shares the same coordinates on the matrix 20 as the bonus symbol 24 and the processor 12 would be prompted to evaluate all “A” symbols on the matrix as if they were entitled to prizes for combinations of scatters, thus the processor awarding a prize for 4 scattered A's. The bonus symbol 24 may act as a scatter pay symbol in the same manner with designated base game symbol(s). Still further, the bonus symbol may define a bonus condition with the base game symbol sharing the bonus symbol coordinate. Other bonus attributes may be assigned to the bonus symbol 24 such as by applying a multiplier for any winning base game symbol combinations including the bonus symbol 24 as shown for example in in FIG. 41. The attributes of the bonus symbol 24 can vary from free game spin to spin and be in addition to other attributes such as being wild, t Thus it may be said that the game symbol sharing the matrix 20 coordinate with the bonus symbol 24 inherits attributes from the bonus symbol 24.

As shown in FIG. 3 by way of example, the bonus symbol 24 Mouse, imparts a “Wild” condition to the assigned coordinate for at least the next play.

Another feature of the present invention is that the triggering of the bonus event also provides to the player a number of free plays while in the bonus event, e.g. free games. The number of free games may be randomly selected, may be fixed or may be based upon the nature of the bonus trigger, e.g. the number of trigger symbols 23 from the base game.

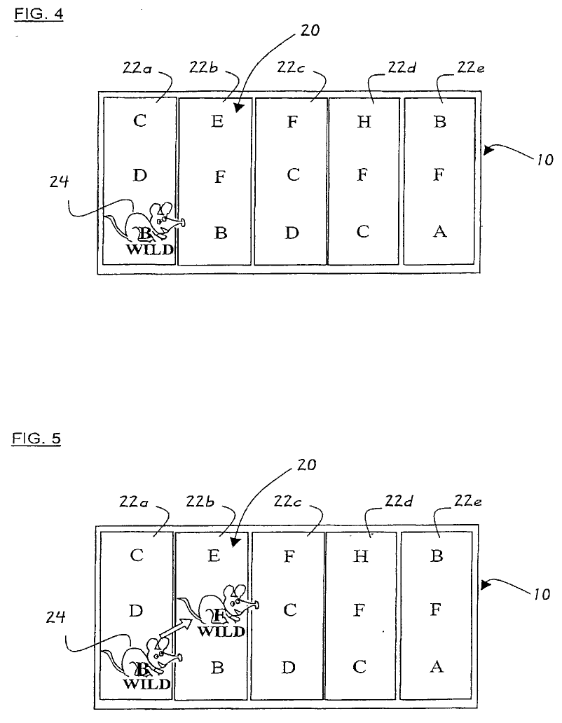

With reference to FIG. 3, there is shown the display 10 as it segues to the display of the subsequent, free spin, outcome. When the bonus event has been triggered, the bonus symbol 24 is placed in the matrix 20 as described above and, based upon the present example, the bonus symbol 24 imparts a Wild condition to the assigned coordinate. The bonus symbol 24 persists in its assigned position during the segue to the display of the next outcome based upon the next free spin of the bonus event, e.g. during the display of the reels 22a-e spinning, in its overlying or underlying or sharing position as suggested in FIG. 3. FIG. 4 shows the display for the outcome of the subsequent free spin during the bonus event. The spinning of the reels 22a-e can be viewed without being completely obscured during the display of the segue.

The subsequent spin outcome is depicted in FIG. 4. The bonus symbol 24 now occupies the same coordinate with a new base game symbol “B”. The processor 12 includes a second data structure 26 (FIG. 10) storing data representing winning bonus outcomes including the bonus symbol 24. The processor 10 at the conclusion of each bonus event spin compares the outcome to the first and second data structures 18, 26 to determine winning outcomes. For example, as shown in FIG. 4, since the bonus symbol 24 is Wild, the player has a winning outcome along a pay line since there are four “F” symbols (three F's plus the Wild symbol). The bonus symbol 24 may also act as a component symbol for a winning scatter pay, e.g. a scatter pay outcome including two A symbols. Still further, since the bonus symbol 24 and another game symbol share the same coordinate, bonus winning outcomes may also be defined by the symbol combinations sharing the same coordinate. For example, and with reference to FIG. 4, a winning combination defined by the second data structure 26 where a B shares the coordinate with the bonus symbol 24.

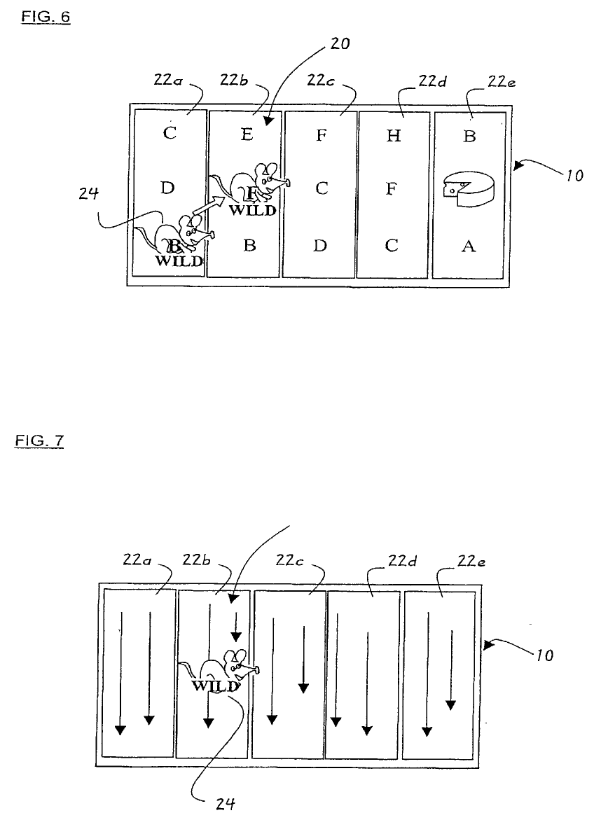

A further feature of the present invention is that after the winning combinations have been determined by the processor 12 and the awards issued, the bonus symbol 24 is moved to another location in the matrix 20 as suggested in FIG. 5. The movement of the bonus symbol 24 to another position may be scripted as by controlling the bonus symbol 24 to move to a designated position on the next reel 22b as shown in FIG. 5 to overlay or underlay the game symbol at that coordinate (the F symbol). Alternatively or additionally, the movement of the bonus symbol 24 may be influenced by displayed game symbols. For example, and with reference to FIG. 6, if a “Cheese” game symbol has been displayed (shown on reel 22e), the bonus symbol 24 “Mouse” may move toward or to the “Cheese” symbol. When repositioned, the next free spin of the bonus event is prompted and the re-positioned bonus symbol 24 remains positioned through the segue and is presented at the re-positioned coordinate for the next outcome. Alternatively the bonus symbol 24 may be repositioned in a fanciful animation during the segue and the bonus symbol 24 reaching its new re-positioned coordinates at the end of the spinning of the reels 22a-e.

Alternatively, and with reference to FIG. 8, game symbols may also influence the bonus symbol 24 to move away from one or more displayed game symbols. As shown the selection and display of a Cat symbol 28 may influence the Mouse bonus symbol 24 to move away from the Cat symbol 28 to a new matrix 20 coordinate.

In still a further embodiment, the player may be able to position the bonus symbol 24 in the matrix 20 in advance of the next spin in the bonus event. Thus the player may attempt to anticipate the outcome and place the bonus symbol 24 in a position where he/she thinks the bonus symbol 24 will result in the highest award.

As before, during the segue (e.g. display of spinning reels) the repositioned bonus symbol remains at the assigned coordinate as shown in FIG. 7. The spinning reel can be viewed underneath/over the bonus symbol. After the segue, the new outcome is displayed and the player receives an award for the free game based upon the symbol combinations, including the repositioned bonus symbol 24, as described above.

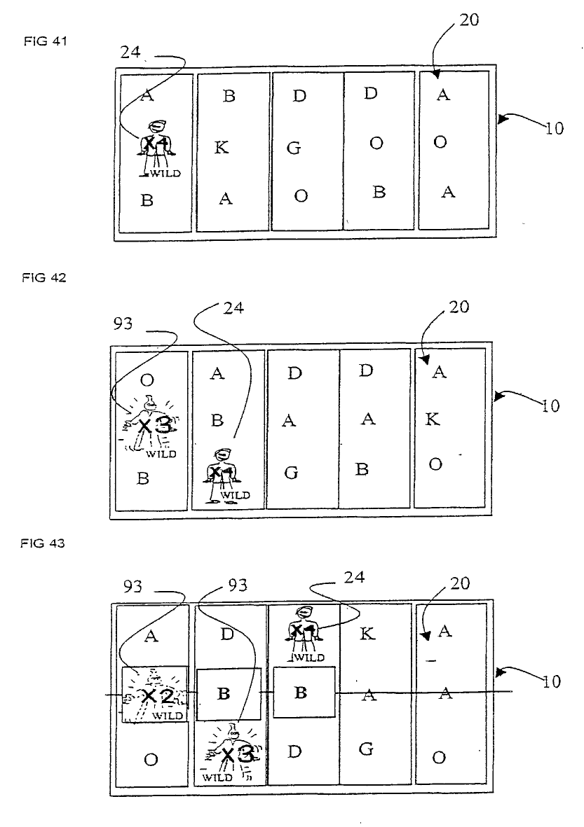

As an alternative feature, the coordinate vacated by the inter-game moving bonus symbol 24 may retain a Wild status during one or more subsequent games during the bonus event. That is, as the bonus symbol 24 is moved for the next free spin, the attribute imposed by the bonus symbol 24 may persist in the vacated coordinates during the allotted set of bonus event games. As shown in FIG. 42 by way of example, at the just vacated coordinates on the matrix 20 by the bonus symbol 24, a companion symbol 93 is displayed with attributes of “wild” and of “multiplier” which were imposed by the bonus symbol as a result of the bonus symbol occupying those coordinates in the previous spin of FIG. 41. The wild attribute is persisting, while the “multiplier” attribute is persisting at a reduced factor. After the segue, the new outcome is displayed in FIG. 43 where again as before at the coordinates just vacated by the bonus symbol a second companion symbol is displayed and where the “multiplier” property of the first companion symbol that persisted from FIG. 42 is further reduced. The player is awarded a prize for winning symbol combinations along an enabled pay line that includes the first companion symbol 93. Thus it can be said that the attributes of the bonus symbol may persist at vacated coordinates during successive free games and where the attributes themselves may decrease in value (i.e. the multiplier attribute persisted at a reduced rate).

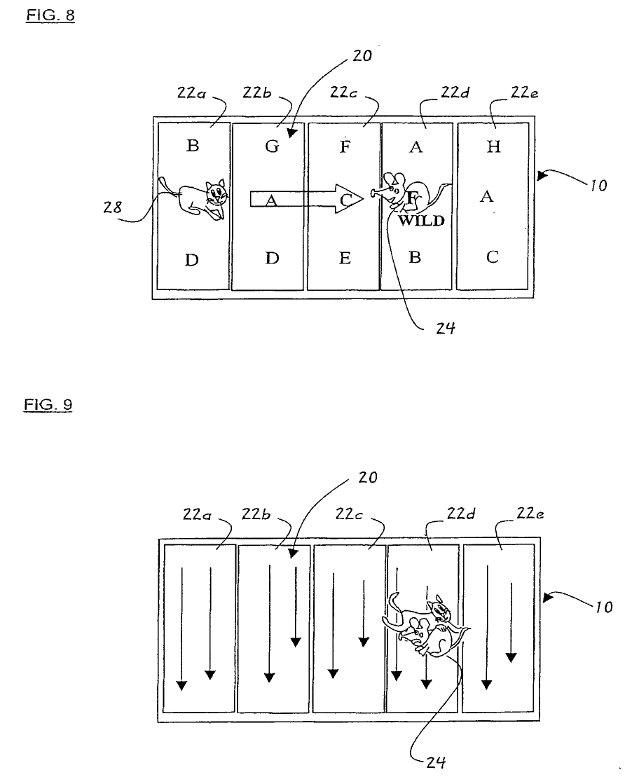

As stated above, when a bonus is triggered, the player is awarded a number of free spins, i.e. spins of play not requiring the player to input a wager. The bonus event may last until exhaustion of the allotment of the free games. Alternatively or additionally, certain outcomes may terminate the bonus event. For example, and with reference to FIG. 9, if the bonus symbol 24 is assigned to a coordinate and the outcome selects a terminating symbol for the same coordinate the bonus event is terminated, i.e. no more free spins and the player is returned to the play of the base game. Alternatively the bonus symbol 24 may be terminated and the free spins continue. As suggested in FIG. 9, where the bonus symbol 24 Mouse and terminating Cat game or assigned bonus event symbol 28 are assigned to the same coordinate, the bonus is terminated. Termination may also be triggered by a terminating symbol being selected for a reel adjacent to the reel containing the bonus symbol, a scatter combination or a base game combination. Termination may also be a consequence of an antagonistic symbol being triggered in a similar fashion as the bonus symbol, during the series of free games. The antagonistic symbol may also persist and move to new coordinates and have attributes and properties in the same manner as the bonus symbol. The antagonistic symbol may virtually have very similar properties and qualities to the bonus symbol and may cause termination when the antagonistic symbol strips the bonus symbol of its attributes or when both symbols move to scripted or randomly selected coordinates of the matrix 20 (for example to adjacent coordinates or adjacent reels).

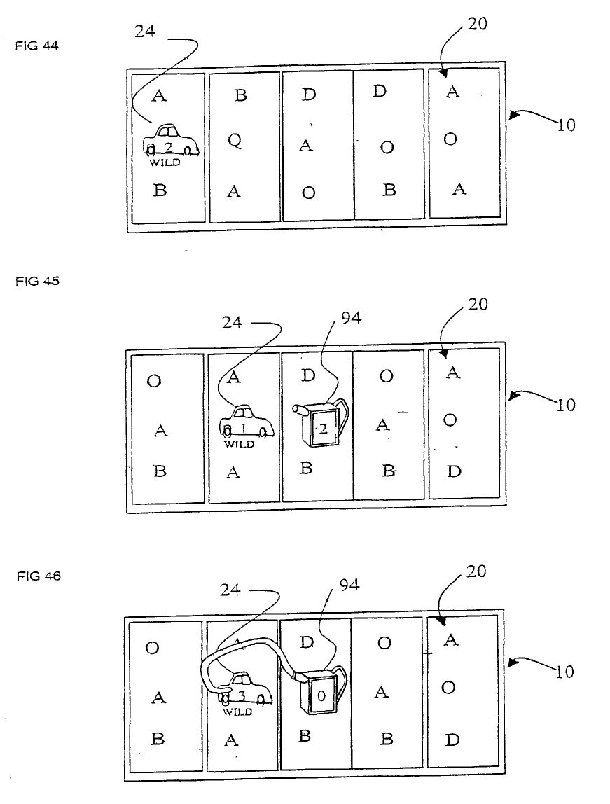

As stated above, when a series of free games is triggered the processor 12 places the bonus symbol 24 on the matrix 20. Termination of the bonus symbol may occur after a scripted or randomly allocated number of moves. In addition the bonus symbol may acquire additional moves during successive spins i.e. free games. As shown by FIG. 44 the bonus symbol 24 can make 2 more moves (i.e. persist in 2 more successive free games) as indicated on the bonus symbol. With reference to FIGS. 45 and 46, a possible free game outcome following the game of FIG. 44, the bonus symbol acquires additional moves from the adjacent refill symbol 94. The refill symbol 94 losses its attributes in favor of the bonus symbol 24 i.e. the refill symbol refills the bonus symbol of additional moves. As can be seen by the example of the sequence of FIGS. 44-46, the bonus symbol 24 started with 2 moves, made 1 move and being so left with 1 move, refilled itself with 2 additional moves, to end up with 3 moves before its termination would occur.

In a similar fashion to the bonus symbol decreasing its property of “number of moves” during successive free games, other properties such as multiplier factors may also decrease between successive free games or may be refilled, i.e reconstituting a number of new moves or multiplier factor by symbols with which the bonus symbol may interact.

The movement and repositioning of the bonus symbol 24 from one game to the next may be animated as may be the termination of the bonus as by showing the Cat symbol 28 catching the Mouse bonus symbol 24 in FIG. 9.

The bonus symbol may also interact with the underlying, overlying or coordinate sharing symbol, to change the base game symbol to another symbol. For example, where the Mouse bonus symbol 24 is positioned, the underlying, overlying or coordinate sharing symbol may be converted into a Wild symbol for the remainder of the allotted free spins as suggested above. For example, and with reference to FIG. 4, the bonus symbol would transform the “B” symbol to a Wild symbol. This transformation would also take place for other game symbols when the bonus symbol 24 is re-positioned as described above. Alternatively, the transformation of symbols could be to other game symbols or different bonus event symbols contained in the second data structure 26.

In the event another bonus event is triggered during the play of a set of free games during a previously triggered bonus, a second bonus symbol 24 is positioned and has the effect and performs in the manner described above. Thus a player could have two or more bonus symbols 24 being repositioned and resulting in bonus awards.

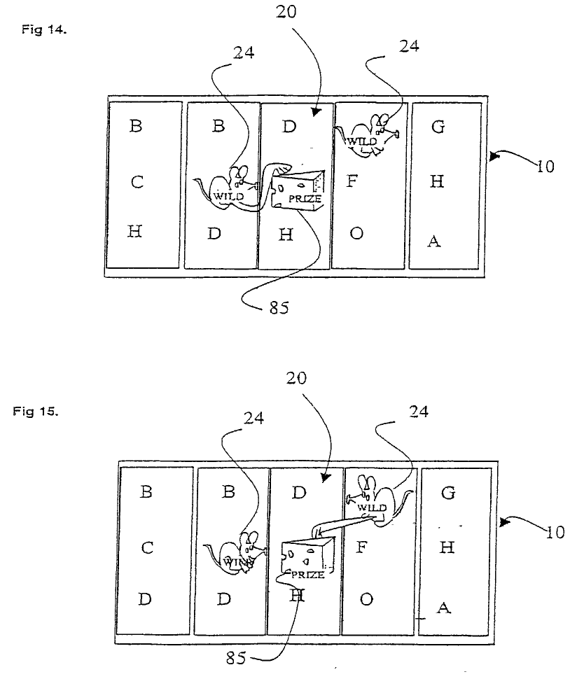

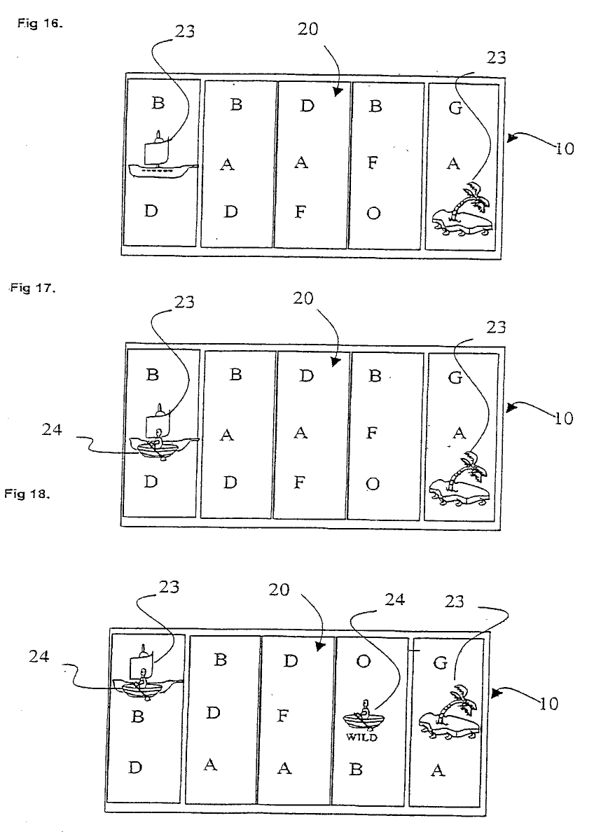

As shown in the examples of FIGS. 16-18, the bonus sequence is started in FIG. 16 by the set of trigger companion game symbols 23 on reels 22a and 22e (boat and an island), then in FIG. 17 the bonus symbol 24 rower in a boat is positioned by the processor 12 in the manner described above on the matrix 20. In FIG. 18 the rower of FIG. 17 has moved to reel 22d and a further trigger for the bonus sequence is detected by the processor 12 as an additional set of symbols 23 are displayed on reels 22a and 22e. An additional bonus symbol 24 is placed on the matrix 20 i.e. an additional rower in a boat is positioned on the display. Thus FIG. 18 displays two bonus symbols 24 to be repositioned in the next free game.

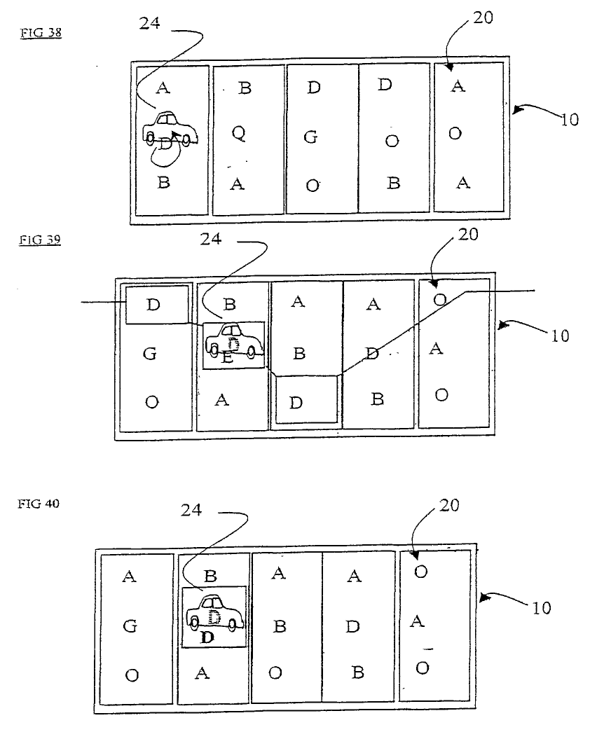

As a further feature of the present invention the bonus symbol 24 may gain or dispose of attributes by interacting with symbols of the matrix 20 or by the processor 12 displaying certain game symbols in the matrix 20. As shown in FIG. 38 by way of example, the bonus symbol 24 acquires the attribute of the overlying/underlying, game symbol that shares the same coordinates on the matrix 20, and retains this attribute for at least the next free game. Thus it may be said that the bonus symbol 24 sharing the matrix 20 coordinate with a game symbol may inherit the attributes of the game symbol. As shown in FIG. 39 the bonus symbol 24 may use the inherited attribute to form a winning combination along an enabled pay line including the bonus symbol 24. i.e. in FIG. 39 the bonus symbol is displayed with the inherited attribute D and the process 12 by detecting game symbols “D” on reels 22a and 22c being along an enabled pay line would be prompted to issue an award. FIG. 40 show another example of the processor 12 being prompted to issue an awards as the inherited property of the bonus symbol matches the game symbol sharing the same coordinates of the matrix 20 (i.e. the inherited property D matches the game symbol D).

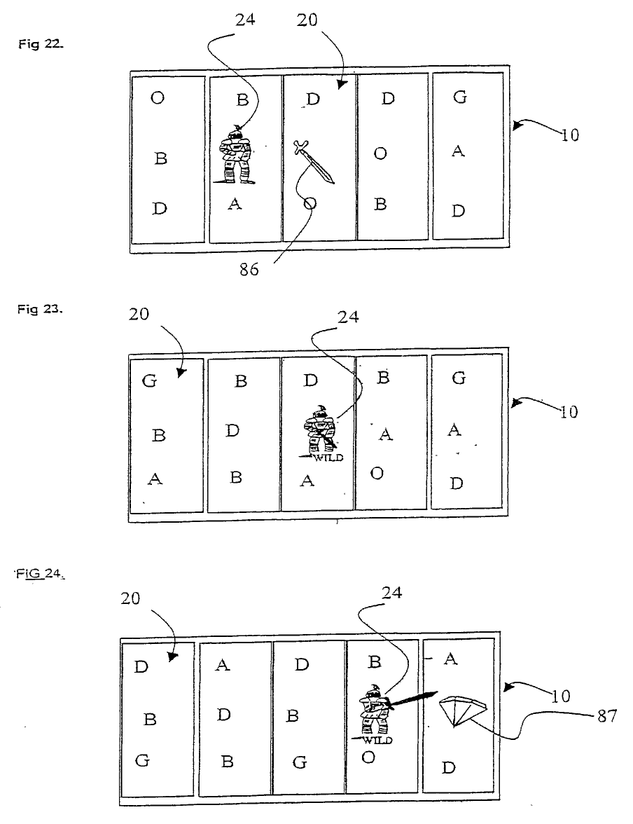

A further example of the bonus symbol acquiring attributes of symbols displayed in the matrix 20 is shown in FIG. 22, where the bonus symbol 24 Knight is displayed adjacent to an attribute symbol 86 Sword. The processor 12 detecting the positioning of the attribute game symbol 86 adjacent to the bonus symbol 24 would cause the attribute symbol to persist at its coordinates into the next free game. During the segue of the next free game (i.e. reel spins) the bonus symbol 24 Knight would move to the same coordinates as the attribute symbol Sword which persisted at its coordinates on the matrix 20. In FIG. 23 an example of a free game outcome following FIG. 22 is shown, where the bonus symbol 24 has acquired the attribute symbol 26 as now being incorporated in the bonus symbol and being a property of the bonus symbol. Thus it may be said that the bonus symbol 24 may pick up attributes from other game symbols during its journey on the matrix 20.

A further example of the bonus symbol gaining attributes is shown in FIG. 20 where the bonus symbol 24 rower acquires the attribute of the game symbol “key” overlying/underlying the bonus symbol. The bonus symbol 24 may use this acquired attribute to interact with game symbols that may be positioned in its proximity, e.g. adjacent reels during successive free games. In an example of free game following the free game outcome of FIG. 20, in FIG. 21 the bonus symbol 24 disposes of the attribute key by placing it back on the matrix 20, so that it may be used by other symbols or in successive free games. Thus it may be said that the bonus symbol may gain or dispose of attributes from game symbols.

As yet another feature of the present invention, the bonus symbol 24 may interact with the game symbol sharing its coordinate by converting the symbol into another bonus symbol 24, into a multiplier, a scatter pay symbol or into another symbol altogether.

As stated above, the bonus symbol may acquire additional attributes while moving between coordinates of the matrix 20. The bonus symbol may then use such attributes to interact with game symbols that are displayed in the matrix 20. As mentioned before the bonus symbol may acquire attributes such as a Sword, as shown in FIGS. 22 and 23. An example of bonus symbol using acquired attributes is provided in the sequence of FIGS. 24-26. In FIG. 24 the bonus symbol 24 Knight in possession of acquired attribute sword 86 interacts with a splitting symbol 87 diamond, where the bonus symbol 24 using the attribute 86 sword is seen hitting the diamond. As a result of the bonus symbol 24 Knight hitting with the acquired sword 86 the splitting symbol diamond 87, as shown in FIG. 25, the splitting symbol is seen separating into shard symbols 88. In the following FIG. 26, the shard symbols 88 move to distinct coordinates in the matrix 20. Thus the bonus symbol 24 may duplicate symbols with which it interacts, or may cause symbols on the matrix 20 to move to new coordinates.

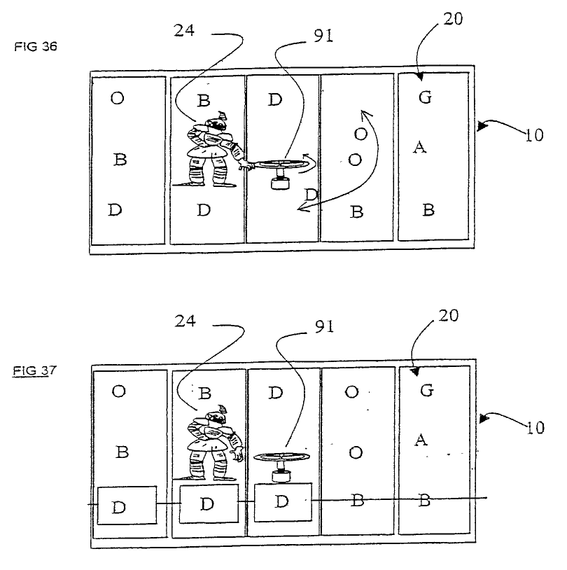

A further example of the bonus symbol 24 causing the rearrangement of symbols on the matrix 20 is provided in the sequence of FIGS. 36 and 37. With reference to FIG. 36, the bonus symbol 24 may use an activator symbol 91 (a non-game symbol placed by the processor 12 when the bonus symbol 24 is placed), by which certain symbols of the matrix are relocated to new coordinates on the matrix. After that the bonus symbol 24 is shown to interact with the activator symbol 91, the symbols 0 on reel 22c and D on reel 22d swap coordinates. In the subsequent FIG. 37 the processor 12 detects the game symbols at the new coordinates and is prompted to award a prize for 3 D's along an enabled pay line. Thus the bonus symbol 24 may rearrange symbols on the matrix 20 indirectly via an activator symbol 91, or using an attribute as mentioned before and with reference to FIG. 26.

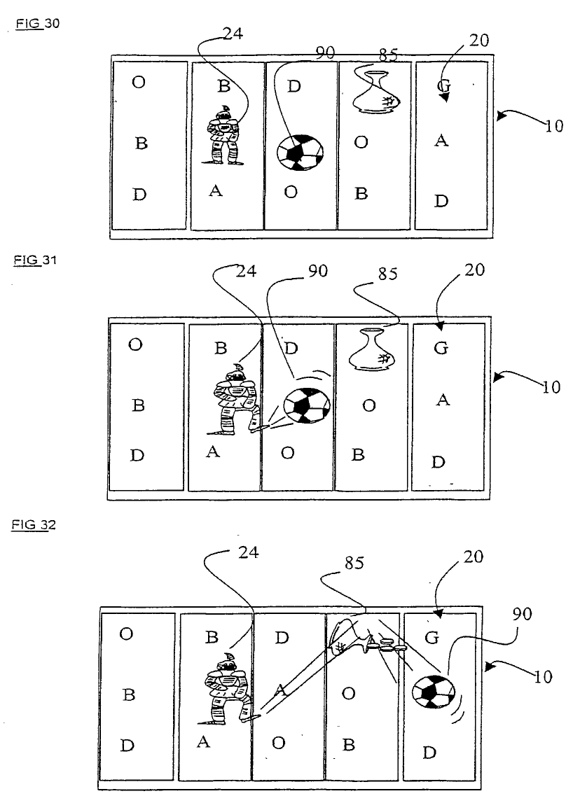

The bonus symbol 24 may also rearrange symbols on the matrix 20 by directly interacting with such symbols and causing them to relocate to new coordinates on the matrix 20. For example in FIG. 30 the bonus symbol 24 is at adjacent coordinates to the transferable symbol 90 Ball, which prompts the processor 12 to initiate the sequence of FIGS. 31 and 32. In FIG. 31 the bonus symbol 24 interacts with the soccer ball 90 and is seen kicking the transferable symbol ball 90 to new coordinates on the matrix. In the animated sequence where the transferable symbol 90 moves to its new coordinates on the matrix 20, the transferable symbol 90 may in turn interact with other symbols on the matrix 20. With reference to FIG. 32, the transferable symbol 90 has interacted with a game symbol 85 vase where it can be seen that the tipped over vase has spilled some coins and the processor 12 awarding a prize according to the data structure 26. Thus the symbols with which the bonus symbol has interacted may in turn interact with other symbols in the matrix 20.

As stated before, the processor 12 may be configured such that game symbols acquire attributes from the bonus symbol 24 up to becoming duplicates to the bonus symbol 24. The game symbol may also acquire other attributes than attributes of the bonus symbol 24, for example attributes of the transferable symbol 90. Thus some other game symbol may become transferable. Alternatively game symbols may acquire attributes from each other or pass attributes on between them. The acquisition of attributes may also be scripted or triggered by game events. As an example of a scripted attribute acquisition, a symbol that interacted with the transferable symbol 90 may acquire the scripted attribute of becoming antagonist to the bonus symbol and may so become a terminating symbol 28 as stated previously. As a further example of scripted acquisition of the terminating attribute, the bonus symbol Mouse mentioned before, may interact with a transferable symbol 90 ball and the ball by hitting a game symbol Kitten may transform it into a terminating symbol (e.g. angry cat) and further imparting to the transformed symbol attributes such as persisting into the next free game. Thus introducing an additional inter free games moving symbol that is not a bonus symbol but a symbol that is antagonistic to the bonus symbol.

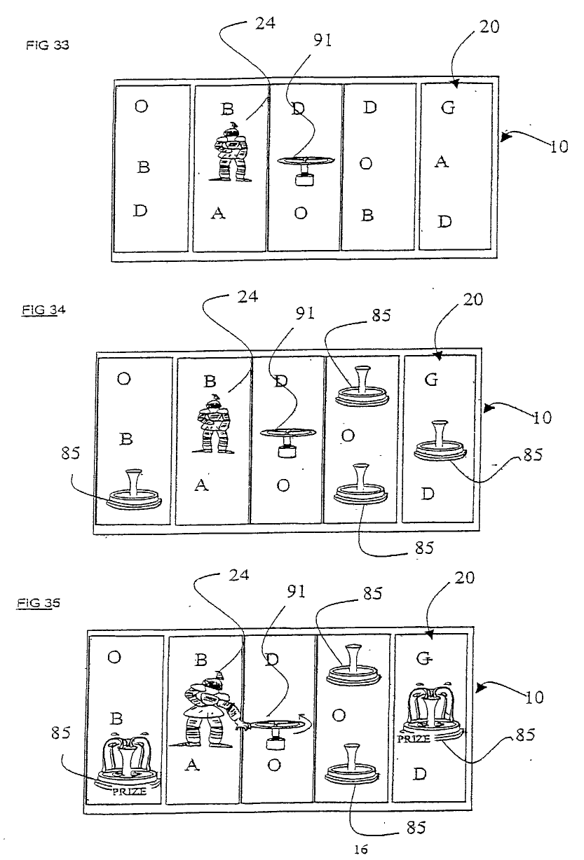

As mentioned before in addition to the bonus symbol 24 gaining or losing attributes, also any other symbol (in addition to the transferable symbol 90) may gain, loose, or passed on attributes. The gaining or losing of attributes may be a consequence of a symbol interacting directly or indirectly with the bonus symbol 24 (e.g. indirectly via an activator symbols 91 or transferable symbol 90) or due to the processor 12 sensing the occurrence of a predetermined free game results or alternatively the processor 12 sensing a number of outcomes in multiple free games. The gaining or losing of attributes by symbols may also be according to scripted rules contained in the data structure 26 of FIG. 10. As an example of scripted attributes gained by game symbols, with reference to the sequence of FIGS. 33-35. In FIG. 33 the bonus symbol 24 is adjacent to an activator game symbol 91 initiating the sequence. The bonus symbol 24 by being positioned adjacent to the activator game symbol 91 in FIG. 34 and by being shown to interact with the activator symbol would cause, symbols at various coordinates in the matrix 20 to assume attributes of being able to prompt the processor 12 of awarding a prizes, thus being treasure symbols 85, depicted as turned off fountains. In FIG. 35 as a further consequence of the bonus symbol 24 interacting with the activator game symbol 91 some of the treasure symbols 85 fountains would be displayed in an animated sequence as turned on, and so prompting the processor 12 to award prizes as stored in the data structure 26.

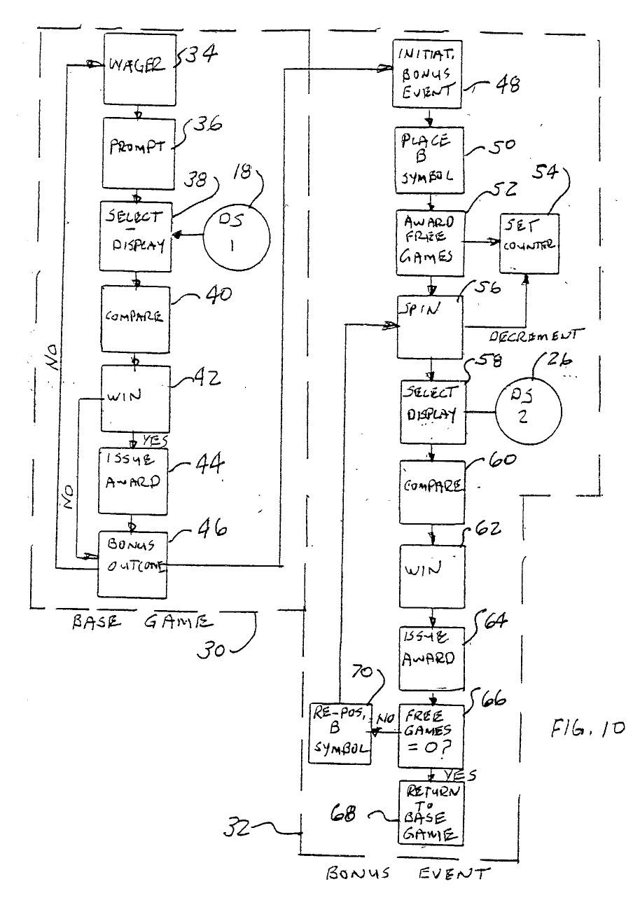

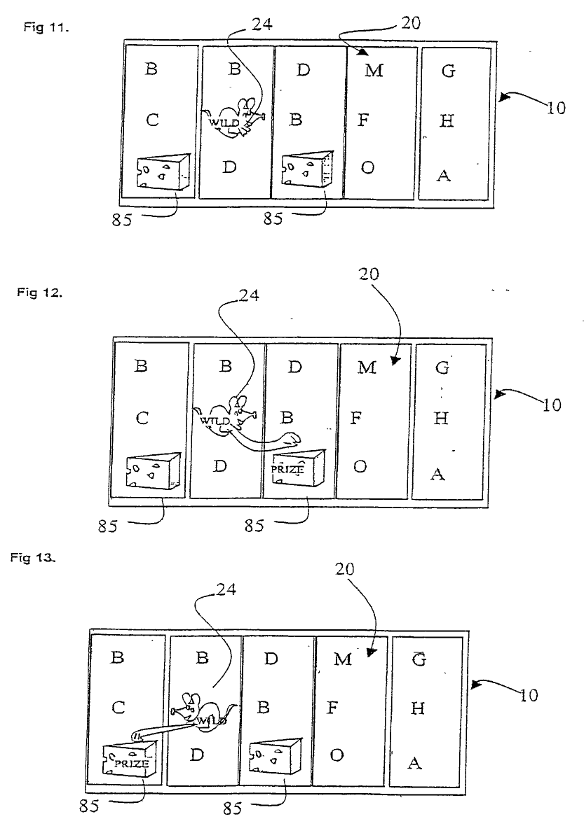

As explained earlier the interaction between symbols may result in the processor awarding prizes, as was the case of the ball hitting the vase in the sequence of FIGS. 30-32 discussed above. The payment of awards may also be due to the interaction between the bonus symbol 24 and a displayed game symbol as illustrated by the sequence of FIGS. 11-13. In this example, and with reference to FIG. 11, the bonus symbol 24 is located on the matrix 20 adjacent to two coordinates with treasure game symbols 85 (cheese wedges) displayed. The processor 12 would thus be prompted to start an animated sequence where, with reference to FIG. 12, the bonus symbol 24 mouse interacts with the first treasure symbol 85, revealing a first prize. As shown in FIG. 13, the processor 12 would then start the second animated sequence where the mouse, by interacting with the second treasure symbol 85, would reveal a second prize. Thus the bonus symbol 24 may interact with a number of treasure symbols 85 revealing a number of prizes.

In case there would be two bonus symbols 24 on the matrix 20 in proximity of a treasure symbol 85, as shown in FIGS. 14 and 15, the bonus symbol 24 mouse would interact in turn with the treasure symbol 85, and each time revealing a prize, which may be different on each occasion. The prize amount awarded may be randomly selected, may be based upon the nature of the treasure symbol, the number of treasure symbols, number of bonus symbols, amount wagered by the player or a combination of these or other factors.

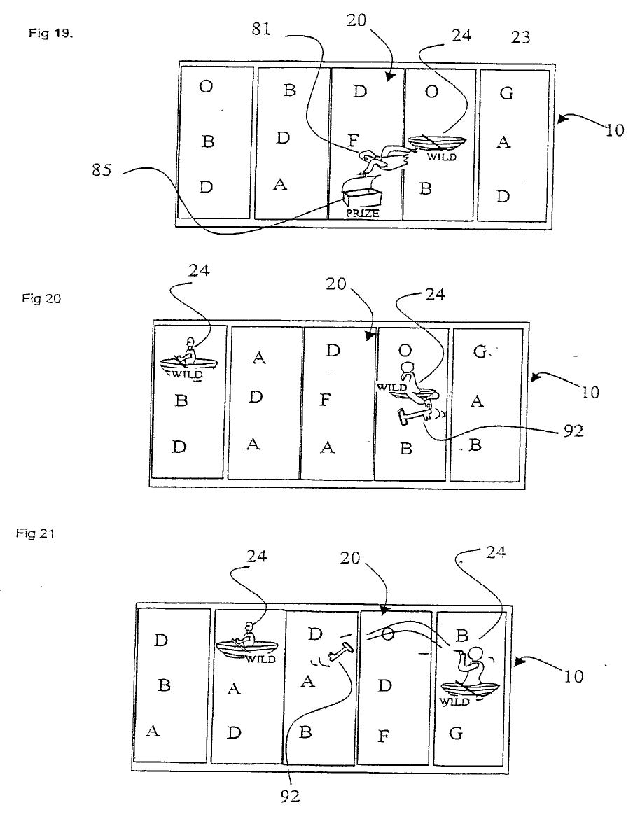

In addition to awards being revealed by direct interaction with the bonus symbol 24, the bonus symbol 24 may avail of a messenger symbol, to participate in the interaction between the bonus symbol and a treasure symbol. The messenger symbol differs from the previously discussed transferable symbol 90, in that it is not a symbol that is displayed on the matrix 20 when the processor 12 starts to evaluate a free game outcome, but is a symbol that originates from the bonus symbol during the process of evaluation. As shown by FIG. 19, the bonus symbol 24 avails of a messenger symbol 81, to interact with the treasure symbol 85, and to so prompt the processor 12 to award a prize according to the data structure 26. It is to be understood that the messenger symbol 81 may be used in addition to interact with treasure symbols 85 also for interaction with other symbols. For example in the case the bonus symbol 24 being a Mouse, a messenger symbol “bowl of milk” may be used to interact with the antagonistic symbol cat, and with fanciful animation the symbol cat may acquire temporary attributes of not being a terminating symbol for at least the next free game, after interacting with the bowl of milk symbol. Thus the messenger symbol may also confer attributes.

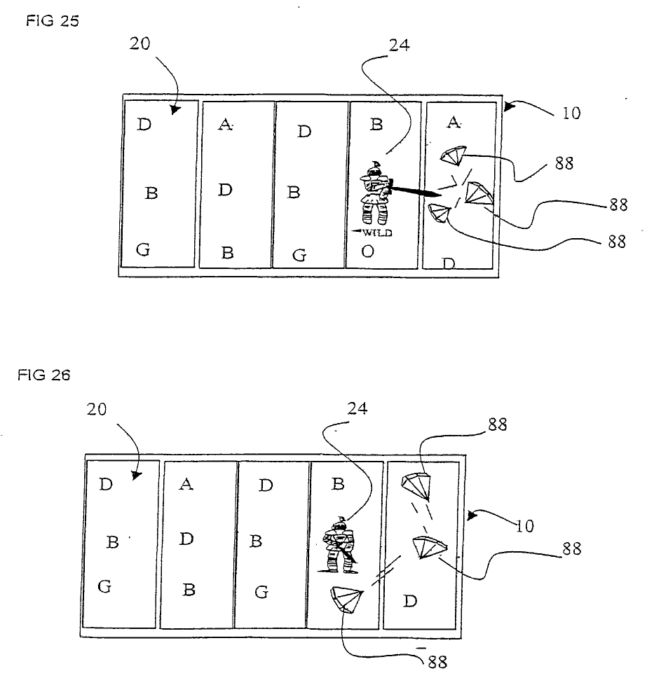

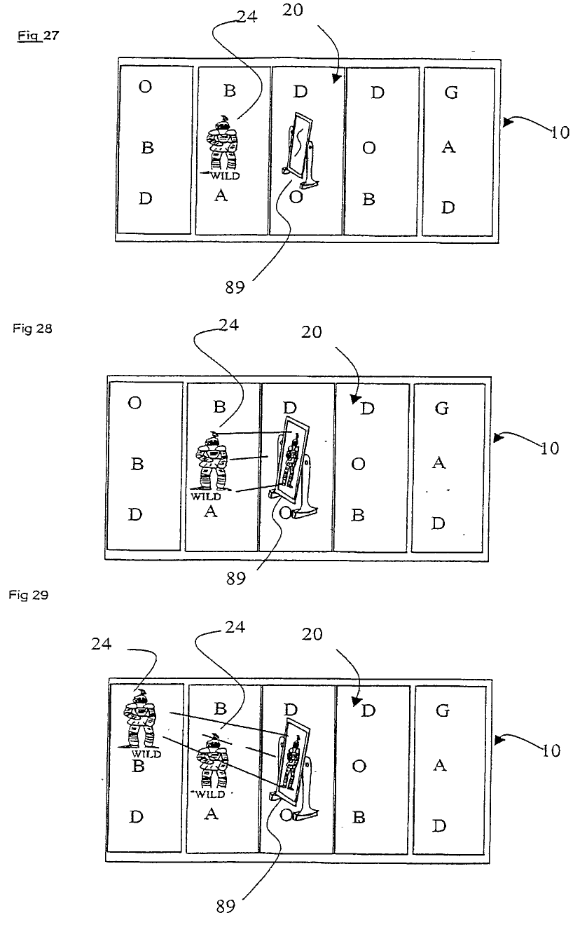

As another feature of the present invention, the bonus symbol 24 may interact with a game symbol that would cause the bonus symbol 24 to be duplicated at some other coordinates on the matrix 20. The duplication may occur via a duplicator game or bonus symbol 89 as shown in the sequence of FIGS. 27-29. As in FIG. 27, the duplicator symbol 89 is located on the matrix 20 adjacent to the bonus symbol 24. The processor 12 would be prompted to initiate an animated succession where, with reference to FIG. 28, the duplicator symbol 89 is seen detecting the bonus symbol 24 and in FIG. 29, the duplicator symbol projecting a copy of the bonus symbol 24 to new coordinates on the matrix 20. The copy of the bonus symbol may be displayed as overlying/underlying the original game symbol at those coordinates on the matrix 20 or may replace the original game symbol. Thus the bonus symbol 24 may be duplicated and both the new and the old bonus symbol would act in the manner explained above during successive free games. The duplicator symbol 89 may be used equally effectively on other game symbols. The duplicating symbol 89 may also store attributes of symbols duplicated previously and may confer such stored attributes to symbols when duplicating other symbols. For example the attribute Wild may be stored and conferred to the next 3 symbols that would be duplicated. Alternatively the duplicating symbol 89 may remove game symbols (or attributes) from the matrix 20, and may reposition them on the matrix 20 next time when it is selected by the processor 12 to be displayed on the matrix. Thus the duplicator symbol 89 may act as a temporary storage for game symbols.

As discussed above the bonus symbol 24 may be surrounded by a number of symbols that posses diverse attributes such as treasure symbols 85, messenger symbols 81, transferable symbols 90, attribute symbols 86, splitting symbols 87, shard symbols split symbols 88, duplicator symbols 89, activator symbols 91, companion symbols 93 or refill symbols 94. The naming of symbols is only for convenience of reference, and it is to be understood that what characterizes symbols are the attributes that they posses. Although in the above, except for the bonus symbol, examples were discussed where symbols had only one attribute, it is to be understood that symbols may have multiple attributes, may have mutating attributes, attributes that increase in magnitude (or decrease) and may gain, loose or dispose of attributes via direct or indirect interaction with other symbols or due to counters, game results, game history or may be scripted.

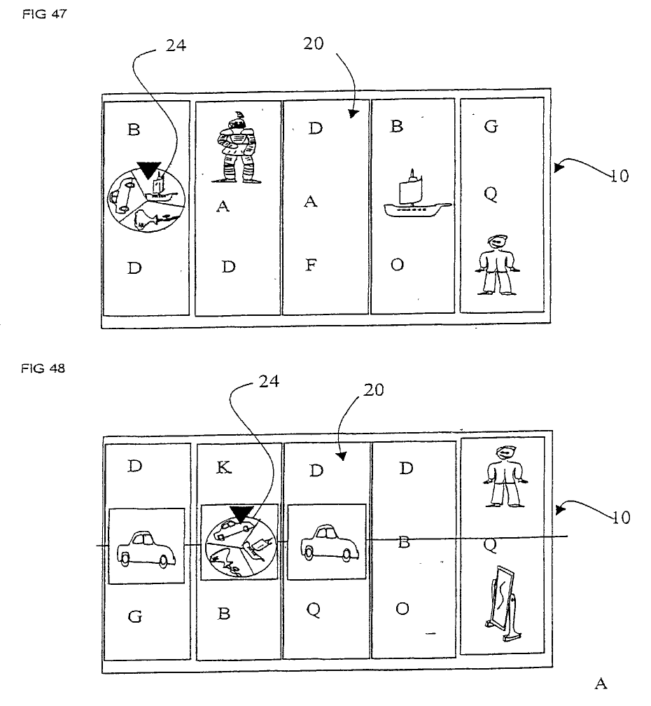

As a further feature of the present invention, attributes that are possessed by the bonus symbol or other game symbols may not all be active at the same time, but may be selectable. The selection of attributes to be active may be random, scripted or the player may be able to select the attribute to be active. Thus the player may attempt to anticipate the outcome and select the attribute to be active that he/she thinks will result in the highest award. An example of selectable attributes is provided in the free games sequence of FIGS. 47 and 48. With reference to FIG. 47, the bonus symbol 24 possesses 3 attributes, each being a game symbol, Car, Vase and Boat. In an example of a successive free game, with reference to FIG. 48, the bonus symbol 24 has moved to the next coordinates on the matrix 20 and the processor 12 has randomly selected the attribute of the bonus symbol 24 for the current free game outcome. The selected attribute is the game symbol car. The processor 12 senses that on an enabled pay line comprising the bonus symbol 24 a winning combination of 3 cars has been formed (2 cars and the selected attribute car of the bonus symbol), thus awarding a prize. As stated above multiple selectable attributes may be possessed by the bonus symbol or other game symbols.

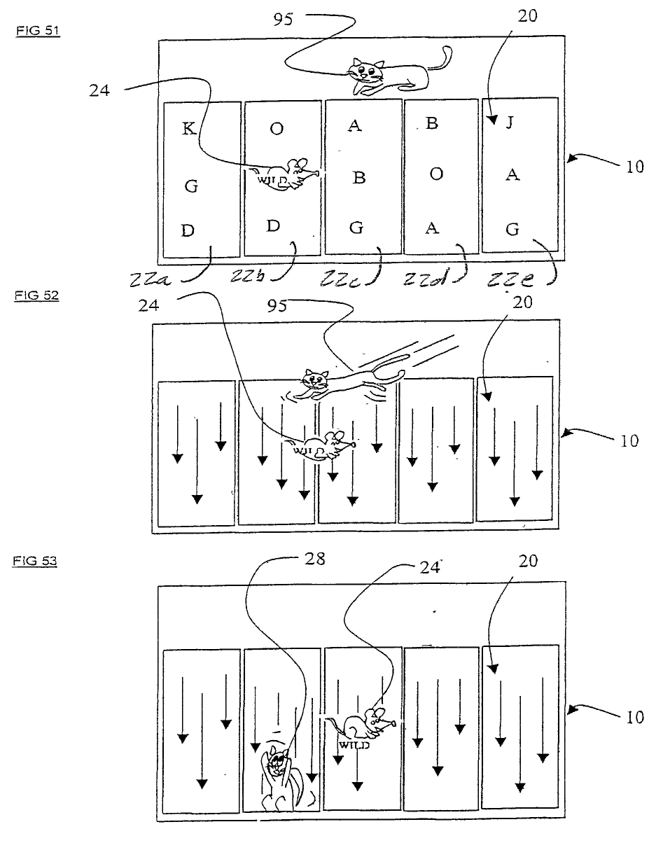

As a yet further feature of the present invention a visiting game symbol may be positioned on the display 10 but outside the matrix 20, thus not forming part of the selectable set of game symbols stored in the data structure 18, and from which the processor 12 selects game symbols to form free games outcomes. Upon a certain trigger condition the processor 12 would be programmed to move the visiting symbol onto one of the reels 22a-e during the segue (i.e. the display reels spin) and thus the visiting symbol becoming part of the reels symbols and being added to the data structure 18 as a selectable game symbol that may be positioned at a coordinate of the matrix 20 as part of an outcome of a free game. The visiting symbol would become integral part of the reel it moved to and would spin off the display in the same manner as other game symbol that are displayed in spinning mode on the reels 22a-e. The trigger condition that prompts the processor 12 to move the visiting symbol onto the reels may be a scripted condition or may be due to a preceding free game outcome or outcomes or be related to base games outcomes. The visiting symbol when moved to a reel may be displayed in overlying or underlying or sharing position with the game symbol of the same coordinates on the matrix 20 in a similar manner as the bonus symbol. The visiting symbol may also be removed from the reels, and form the data structure 18, by the processor 12 and positioned on the display 10 outside the matrix 20, thus removing the visiting symbol from the set of selectable game symbols. The triggering conditions for removing the visiting symbol may again be similar to those that prompted the processor to move the visiting symbol onto the reels. An example of the processor placing the visiting symbol onto the reels is provided by the sequence of FIGS. 51-53. With reference to FIG. 51, the visiting symbol 95 Cat is positioned on the display 10 outside the matrix 20. The processor by sensing the trigger condition of the bonus symbol 24 Mouse being displayed at a coordinate of the matrix 20, is prompted during the next free game display of reels spin, to move the visiting symbol 95 onto reel 22b at the coordinate of the matrix 20 where the mouse 24 was located before being moved by the processor 12 to its next coordinate, as indicated in FIG. 52. The visiting symbol then in FIG. 53 becomes a game symbol displayed on the reels and is treated by the processor 12 like the Cat symbol 28 of FIG. 8 or FIG. 9. Thus the visiting symbol 95 has practically mutated into a terminating symbol 28 and can now be selected by the processor 12 as a game symbol to form part of a free game outcome.

Turning to FIG. 10 the system and method will be further described. The base game 30 acts with the bonus event game 32. The base game 30 is played by, at 34, the player inputting a wager at the wager input device 14 for activating one or more pay lines for the base game 30. At 36 a play or “spin” of the base game 30 is prompted and the processor 12, in response to the prompt, at 38 selects and displays the base game outcome at the display 10 matrix 20. The outcome is randomly selected from the first data structure 18 storing data representing game symbols or combinations of game symbols. The processor 12 compares at 40 the selected and displayed outcome to data representing winning outcomes. If at 42 the player has obtained a winning outcome on any enabled pay lines, at 44 the player is issued the corresponding award(s). The player may have winning base game symbol combinations on one or more pay lines. The processor 12 further compares the base game outcome to a predetermined symbol or symbol combination to determine at 46 if the selected outcome includes a bonus event trigger. If no trigger is present, the base game 30 returns to the start for the player to input another wager at 34. If a trigger has been displayed, at 48 the bonus game event is initiated.

Upon initiation of the bonus event game at 48, the processor is configured to, at 50 to, place the bonus symbol 24 in the display 10 matrix 20 for the base game in the manner described above and at 52 awards an allotment of free bonus games or spins. A spin counter 54 is also initialized to count down the allotted free games. The first free spin is prompted at 56 (the counter is decremented one spin) and at 58 the processor selects and displays the first free game outcome at the display 10. The game symbols selected may be selected from the first data structure 18 containing data representing base game 30 symbols or a separate inventory of data representing bonus game symbols represented in the second data structure 26. The data of the second data structure 26 may include base game symbol data as well as different bonus event symbol data or data about symbol attributes and game rules. As but an example, the second data structure 26 may include data representing bonus event symbols for interacting with the bonus symbol 24 to produce awards, a bonus terminating event, special bonuses, symbol conversions, influence regarding the repositioning of the bonus symbol 24, scripted attributes, or the like. At 60 the bonus event outcome is compared by the processor 12 to determine at 62 if the player has obtained a winning outcome. If a winning bonus event outcome has been obtained at 62, at 64 the award is issued to the player. It should be noted that, during the bonus event, all outcomes may be designated as winning outcomes. At 66 the processor 12 accesses the counter 54 to determine if any free games remain from the allotted number or if a bonus terminating outcome has occurred. If the bonus event has been terminated by exhaustion of the allotted free games or a bonus terminating outcome or by a sequence of events occurred in successive free spins, at 68 the player is returned to the base game 30. If not, at 70 the bonus symbol 24 is re-positioned in the game matrix 20 and at 56 the next free spin is prompted. The prompting of the spins of the free games may be automatic or may require an input prompt by the player. Where the player positions the bonus symbol 24, it will be required that the player prompt the free spins.

Thus the device and method of the present invention provides for the triggering of the bonus event. The bonus event includes placement of at least one bonus symbol 24 in the matrix 20 preferably in an overlying, underlying or juxtaposed position in the matrix coordinate with the then present game symbol. The game symbol or matrix coordinate inherits attributes from the applied bonus symbol. Further, for an allotted number of free games, the bonus symbol moves to other matrix 20 coordinates conferring its bonus attributes to the, for example, underlying game symbol in the coordinate. Still further, by providing interaction between the bonus symbol 24 and coordinate, co-tenant game symbol, the game and device provide a degree of three-dimensionality to the game. Still further the bonus symbol by interacting with game symbols, exchanges or acquires attributes, attributes that can increase, decrease, be lost or deposited, or the bonus symbols duplicating symbols or being duplicated. The interaction extending to any game symbol, by which providing a degree of activity that would give qualities to game symbols similar and beyond to those of to people in a community, whereby providing a small fantasy world of interacting symbols, where successive free games may be compared to days of our live.

While we have shown and described certain embodiments of the present invention, it should be understood that it is subject to many modifications and changes without departing from the spirit and scope of the appended claims.

I claim:

1. An improved electronic gaming device of the type including a display, means for accepting wagers to play a series of game plays, a processor programmed to, when prompted, control the display to display at least three reels each in a spinning mode concluding at a stopped mode whereat a plurality of game symbols are displayed on said reels defining a two dimensional game matrix with coordinates occupied by game symbols, and defining one or more winning or a losing outcomes based on the combination of game symbols displayed on said reels and means for issuing a reward to the player when a winning outcome is obtained, the improvement comprising:
said processor adapted to sense the occurrence of a predetermined bonus triggering event;
in response to sensing said triggering event, said processor configured to initiate a bonus sequence including,
(i) re-configuring the game for at least two free games play and
(ii) controlling the display to display a bonus symbol, and
(iii) during the play of at least one of the said free games control the bonus symbol to be displayed to occupy at least the coordinates of for one game symbol of the game matrix with the game symbol displayed thereat, said bonus symbol assigned at least one bonus attribute of at least one of being wild, act as a multiplier, co-acting with game symbols, changing game symbols, persisting though a plurality of games, changing the attributes of game symbols or becoming an additional game symbol;
(iv) for at least one free game reposition the bonus symbol into different positions in the game matrix to be displayed with at least one game symbol thereat;
a device to prompt sequential play of said free games, each play selecting and displaying a new set of game symbols at the game matrix;
a data structure storing data corresponding to winning bonus game outcomes including at least one said bonus symbol attribute or said bonus symbol attribute compared to displayed game symbols or said bonus symbol attribute and any changed game symbol and for each winning outcome an award;
said processor configured to, for each game of the bonus sequence compare the bonus symbol with the game symbols displayed at the display to said winning bonus outcome data of said data structure to determine if a winning outcome has been obtained issue the award; and
said processor configured to terminate said bonus sequence in response to a bonus terminating event.

2. The improved device of claim 1 comprising said processor configured to assign and display the said bonus symbol at a selected coordinates of the said game matrix coordinates to co-habit the coordinates with a game symbol.

3. The improved device of claim 1 comprising said processor configured to, for at least two of said free games reposition the bonus symbol on the said game matrix to occupy other coordinates to another coordinate.

4. The improved device of claim 1 comprising said processor configured to, after assigning the said bonus symbol to coordinates of the said game matrix coordinate, reposition said bonus symbol influenced by said displayed game symbols of a said subsequent bonus free game outcome.

5. The improved device of claim 1 comprising said processor assigning to said bonus symbol an attribute of being a wild symbol for game symbols for purposes of determining winning bonus outcomes.

6. The improved device of claim 1 comprising said processor configured to terminate said bonus sequence of free games as a result of selection of at least one predetermined game symbol.

7. The improved device of claim 1 comprising said processor configured to initiate a second bonus sequence when, during a first bonus sequence, sensing a bonus triggering event.

8. The improved device of claim 1 comprising said processor configured to define said bonus triggering event as a pre-selected game outcome.

9. The improved device of claim 1 comprising said processor configured to, after assigning the said bonus symbol at to coordinates of the said a game matrix coordinate to, assign the attribute of the co-habiting game symbol to the bonus symbol for at least one of the subsequent free game outcomes.

10. The improved device of claim 1 comprising said processor configured to in response to sensing a bonus symbol trigger event, to assign and display a second bonus symbol at coordinates of the said a game matrix coordinate.

11. The improved device of claim 1 comprising said processor configured to initially display said bonus symbol adjacent the said game matrix and to, in a subsequent free game, move the bonus symbol into coordinates of the said game matrix coordinate.

12. The improved device of claim 1 comprising the said processor configured to assign to the bonus symbol an attribute of converting the game symbol to a scatter pay symbol and re-configure said data structure to include an award for selection and display of a predetermined number of scatter pay symbols.

13. The improved device of claim 1 comprising the processor configured to assign to the bonus symbol an attribute of acting as a multiplier of any game symbol winning outcome award embracing the coordinates of the bonus symbol.

14. The improved device of claim 13 comprising the processor configured to assign the said multiplier to the bonus symbol an attribute of persisting in any coordinates of the game matrix occupied by the bonus symbol, and said attribute persisting during a set of subsequent free games of the said bonus sequence. during the free game bonus game set.

15. The improved device of claim 14 comprising said bonus symbol multiplier value changing and persisting as the bonus symbol is moved in the game matrix from free game to free game.

16. The improved device of claim 1 comprising the said processor configured to assign to the bonus symbol an attribute of conferring at least one bonus symbol attribute to the game symbol co-habiting the coordinates with the bonus symbol.

17. The improved device of claim 1 comprising said processor configured to define the said attribute of said bonus symbol as having the property of one of duplicating the co-habiting game symbol, relocating game symbols on the said game matrix, or as having the property of removing or adding symbols on the said matrix coordinates.

18. The improved device of claim 1 comprising said processor configured to assign and display the said bonus symbol at coordinates of the said game matrix coordinate in one or an overlay or underlay configuration with any game symbol displayed at the assigned coordinates assigned to the bonus symbol.

19. The improved device of claim 1 comprising the said processor configured to move and remove a said reel game symbol from its game matrix coordinates and place it on the display off the said reels and said game matrix coordinates, and leave such symbol for at least one successive free game of the said bonus sequence off the said reels and said game matrix coordinates.

20. The improved device of claim 1 comprising the said processor configured to assign to a said game symbol multiple attributes that defines additional winning outcomes, and the said processor configured to select at least one said multiple attributes to be taken in consideration by the processor when determining winning bonus outcomes.

21. The improved device of claim 1 comprising the said processor configured to assign additional attributes to game reel symbols that had attributes assigned by the processor in previous free games of the said bonus sequence.

22. The improved device of claim 1 comprising the said processor configured to take away said attributes from game reel symbols that had attributes assigned by the processor in previous free games of the said bonus sequence.

23. The improved device of claim 1 comprising said processor configured to, after assigning the said bonus symbol to coordinates of the said game matrix to, assign the attribute of any of the game symbols displayed in the game matrix to the bonus symbol for at least one of the subsequent free game outcomes.

24. The improved device of claim 1 comprising the said processor configured to assign to the bonus symbol an attribute of conferring at least one bonus symbol attribute to any game symbol displayed in the game matrix.

25. An improved method for playing a game of the type where a player inputs a wager to play, providing a processor programmed to, when prompted, control an electronic display to display at least three reels each in a spinning mode concluding at a stopped mode whereat a plurality of reel symbols are displayed on said reels defining a game matrix with of matrix coordinates occupied by reel symbols and defining a winning or a losing outcome based on the combination of symbols displayed on said reels and issuing a reward to the player when a winning outcome is obtained, the improvement comprising:
configuring said processor to sense the occurrence of a predetermined bonus triggering event; at least the coordinates for one game symbol of the
in response to sensing said triggering event, said processor initiating a bonus sequence including (i) re-configuring the game for at least one free game play and (ii) controlling the display to assign and display a bonus symbol at a game matrix coordinates on the game matrix in one or an overlay. underlay or juxtaposed position with any reel symbol displayed at the assigned coordinates, and for each free game of the bonus sequence reposition the bonus symbol to a different coordinates of the matrix;
storing a first data structure of data corresponding to winning bonus game outcomes including said bonus symbol and for each winning outcome an award;
said processor, for each free game of the bonus sequence, (i) comparing the reel symbol and bonus symbol outcomes displayed at the display to said winning bonus outcome data of said first data structure to determine if a winning outcome has been obtained issue the award; and
terminating said bonus sequence in response to a bonus terminating event.

26. An improved method for playing a game of the type where a player inputs a wager to play, providing a processor programmed to, when prompted, control an electronic display to display at least three reels each in a spinning mode concluding at a stopped mode whereat a plurality of reel symbols are displayed on said reels defining a game matrix with matrix coordinates occupied by reel symbols and defining a winning or a losing outcome based on the combination of symbols displayed on said reels and issuing a reward to the player when a winning outcome is obtained, the improvement comprising:
configuring said processor to sense the occurrence of a predetermined bonus triggering event; at least the coordinates for one game symbol of the
in response to sensing said triggering event, said processor initiating a bonus sequence including (i) re-configuring the game for at least one free game play and (ii) controlling the display to assign and display a bonus symbol at any coordinates on the game matrix by replacing the reel symbol displayed thereat, and for each free game of the bonus sequence reposition the bonus symbol to different coordinates of the matrix;
storing a first data structure of data corresponding to winning bonus game outcomes including said bonus symbol and for each winning outcome an award;
said processor, for each free game of the bonus sequence, (i) comparing the reel symbol and bonus symbol outcomes displayed at the display to said winning bonus outcome data of said first data structure to determine if a winning outcome has been obtained issue the award; and
terminating said bonus sequence in response to a bonus terminating event.
